(19) United States
(12) Patent Application Publication
(10) Pub. No.: US 2007/0146800 A1
(43) Pub. Date: Jun. 28, 2007

(54) Method of controlling an image forming apparatus to store a photodrama

(75) Inventor: Jong-un Jeong, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/541,539

(22) Filed: Oct. 3, 2006

(30) Foreign Application Priority Data
Dec. 26, 2005 (KR) 2005-129589

(51) Int. Cl. G06K 15/00

(52) U.S. Cl. 358/302; 358/1.16

(57) ABSTRACT

A method of controlling an image forming apparatus to store a photodrama includes arranging and storing a plurality of image files in a photodrama folder based on corresponding input image information to display the images of the image files; and storing the input image information with the stored plurality of image files in the photodrama folder.

### CROSS-REFERENCE TO RELATED APPLICATIONS

This application claims priority under 35 U.S.C. § 119(a) from Korean Patent Application No. 2005-129589, filed Dec. 26, 2005, the contents of which are incorporated herein by reference in its entirety.

### BACKGROUND OF THE INVENTION

1. Field of the Invention

The present general inventive concept relates to a method of controlling an image forming apparatus. More particularly, the present general inventive concept relates to a method of controlling an image forming apparatus to store a photodrama.

2. Description of the Related Art

As digital cameras are being developed and uses thereof widespread, users' demand for outputting a photographed image directly onto a paper for preservation as well as merely storing the image photographed by the digital cameras in a storage medium is increasing.

As a consequence, a photo printer has been introduced to meet such demands. The photo printer, which is dedicated for digital photos, prints an image stored in a digital camera connected through a PictBridge and prints an image stored in a mobile memory card. By using a photo paper, the photo printers are capable of realizing photos having equivalent image quality to general film photos.

The photo printers of these days are equipped with a high-capacity hard disc and a large-size liquid crystal display (LCD), thereby applying a variety of functions including a display function. Such various functions can be utilized conveniently by directly transmitting images stored in the digital camera or the mobile memory card to the photo printer.

Meanwhile, according to the widespread use of the digital cameras, various genres of art including a photodrama have been developed using images photographed by the digital cameras. The photodrama is constructed by sequencing a series of photographed images to compose a certain story, similarly to a drama.

In order to construct the photodrama, generally, a user generates a separate folder and sequences in the folder a plurality of still images or still cuts sampled from an animation. Then, the user performs editing of the photodrama in person (i.e., manually), such as an insertion of texts for each image. Thus, the photodrama requires complicated and laborious work.

Furthermore, when the user wants to print out the photodrama, the stored images are transmitted by connecting the digital camera or the mobile memory card to a computer, an application program is downloaded from the computer to make the photodrama by editing and sequencing the images, and the completed photodrama is transmitted to a connected printer. Thus, a printing of the photodrama is inconvenient and cumbersome for the user.

### SUMMARY OF THE INVENTION

The present general inventive concept provides a method of controlling an image forming apparatus to conveniently edit and/or store a photodrama in the image forming apparatus.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing a method of controlling an image forming apparatus to store a photodrama, the method including arranging and storing a plurality of image files in a photodrama folder based on corresponding input image information to display images of the image files, and storing the input image information with the stored plurality of image files in the photodrama folder.

The input image information may include an arrangement order of the plurality of images.

The storing of the input image information may include storing the input image information as an exchangeable image file format (Exif) file in the photodrama folder.

The method may further include displaying the images, and displaying an editing screen to input the input image information thereto.

The editing screen may include a keypad including numbers and letters to input of the input image information.

The displaying of the editing screen may include displaying the input image information input through the keypad as a pop-up window.

The photodrama folder may be an existing photodrama folder or a new photodrama folder, and the storing of the input image information may include storing the input image information in the existing photodrama folder with the plurality of image files, or creating the new photodrama folder and storing the input image information in the new photodrama folder with the plurality of image files as each of the plurality of image files is generated.

The photodrama folder may be represented by an icon distinguishable from other folders.

The input image information may include editing data to edit the images.

The editing data may include text to describe the images.

The method may further include editing and displaying the text together with the images according to the input image information.

The storing of the input image information may include storing the input image information as separate files separate from the plurality of image files in the photodrama folder.

The method may further include storing the input image information integrally with the plurality of image files in the photodrama folder.

The method may further include performing at least one of displaying and printing the images stored and arranged according to the input image information.

The performing of the at least one of displaying and printing may include arranging the images based on a predetermined layout according to the input image information.

The performing of the at least one of displaying and printing may include arranging the input image information together with the images.

The method may further include inputting at least one of a display option and a print option, and performing the at least one of displaying and printing according to the input at least one display option and print option, respectively.

The foregoing and/or other aspects and utilities of the present general inventive concept may also be achieved by providing an image forming apparatus, including a storage unit to store a photodrama folder containing a plurality of image files and corresponding input image information to display images of the image files, and a control unit to arrange and store the plurality of image files in the photodrama folder based on the corresponding input image information, and to store the input image information with the stored plurality of image files in the photodrama folder.

The foregoing and/or other aspects and utilities of the present general inventive concept may also be achieved by providing an image forming apparatus to edit and store a photodrama, including a display unit to display an editing screen to edit one or more of a plurality of images, a control unit to generate editing data corresponding to the one or more of the plurality of images to arrange, store, and display the plurality of images according to a predetermined order on the display unit, and a storage unit to store the generated editing data in a photodrama folder together with image files corresponding to the plurality of images.

The storage unit may store the generated editing data as separate files separate from the image files in the photodrama folder. The storage unit may store the generated editing data in a header of corresponding ones of the image files.

The photodrama folder may be a previously-created photodrama folder. The storage unit may store other folders, the other folders may be represented by a first icon, and the photodrama folder may be represented by a second icon that is visually distinguishable from the first icon. The photodrama folder may be a newly-created photodrama folder. The control unit may generate an icon representing the newly-created photodrama folder that is visually distinguishable from other folders stored in the storage unit.

The control unit may generate at least one of an image sequence number and an image description for the one or more of the plurality of images. The image description may include a font type, a text size, and/or a position of the description. The display unit may display the editing screen as an options screen overlapping the one or more of the plurality of images to edit the one or more of the plurality of images.

The foregoing and/or other aspects and utilities of the present general inventive concept may also be achieved by providing a method of editing and storing a photodrama in an image forming apparatus, the method including displaying an editing screen to edit one or more of a plurality of images, generating editing data corresponding to the one or more of the plurality of images to arrange, store, and display the plurality of images according to a predetermined order, and storing the generated editing data in a photodrama folder together with image files corresponding to the plurality of images.

The storing may include storing the generated editing data as separate files separate from the image files in the photodrama folder. The storing may include storing the generated editing data in a header of corresponding ones of the image files.

The photodrama folder may include a previously-created photodrama folder. An icon representing the previously-created photodrama folder may be visually distinguishable from other folders stored in the image forming apparatus. The storing may include creating the photodrama folder, and storing the generated editing data in the created photodrama folder together with the image files in the predetermined order. The storing may further include creating an icon representing the created photodrama folder that is visually distinguishable from other folders stored in the image forming apparatus.

The generating of the editing data may include generating at least one of an image sequence number and an image description for the one or more of the plurality of images. The image description may include a font type, a text size, and/or a position of the description. The displaying of the editing screen may include displaying the editing screen as an options screen overlapping the one or more of the plurality of images to edit the one or more of the plurality of images.

The foregoing and/or other aspects and utilities of the present general inventive concept may also be achieved by providing a computer readable recording medium including a computer readable code to perform a method of editing and storing a photodrama in an image forming apparatus, the method including displaying an editing screen to edit one or more of a plurality of images, generating editing data corresponding to the one or more of the plurality of images to arrange, store, and display the plurality of images according to a predetermined order, and storing the generated editing data in a photodrama folder together with image files corresponding to the plurality of images.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram schematically illustrating a photo printer according to an embodiment of the present general inventive concept;

FIG. 2 is a flowchart illustrating operations of the photo printer of FIG. 1 according to an embodiment of the present general inventive concept; and

FIG. 3 is a view illustrating an exemplary editing screen of the photo printer of FIG. 1 to edit a photodrama according to the method of FIG. 2;

FIG. 4 is a view illustrating an exemplary icon denoting a photodrama folder of the photo printer 100 of FIG. 1 according to an embodiment of the present general inventive concept;

FIG. 5A is a view illustrating an exemplary Exif file of information on an image file stored in a general folder according to an embodiment of the present general inventive concept;

FIG. 5B is a view illustrating an exemplary Exif file of information on an image file stored in the photodrama folder of FIG. 4 according to an embodiment of the present general inventive concept;

FIG. 6A is a view illustrating an exemplary photodrama displayed or printed through a display part of the photo printer 100 of FIG. 1 according to an embodiment of the general inventive concept; and

FIG. 6B is a view illustrating exemplary layouts to display and print the photodrama of FIG. 6A according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

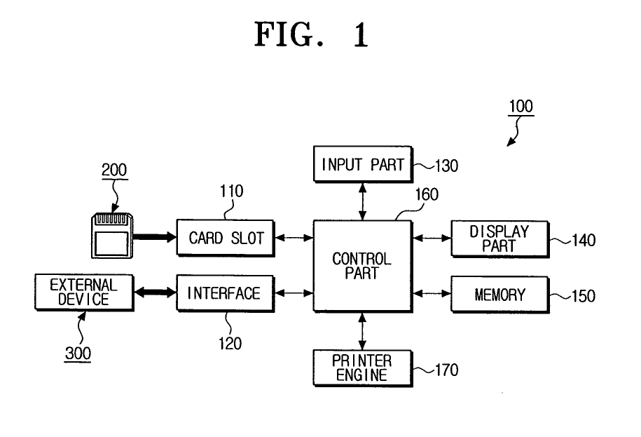

FIG. 1 is a block diagram schematically illustrating a photo printer 100 according to an embodiment of the present general inventive concept. Although the photo printer 100 is described and illustrated with reference to the present embodiment, the present general inventive concept is not limited thereto. The present general inventive concept is applicable to other image forming apparatuses, such as a printer and a multifunction peripheral apparatus capable of displaying and storing images.

Referring to FIG. 1, the photo printer 100 according to the present embodiment may include a card slot 110, an interface 120, an input part 130, a display part 140, a memory 150, a control part 160, and a printer engine 170.

The card slot 110 is a slot to mount a mobile memory card 200. A plurality of card slots 110 may be provided. The mobile memory card 200 may serve as a flash memory and may store at least one image photographed by an image photographing device, such as a digital camera (not illustrated).

The mobile memory card 200 may be, for example, a multimedia card (MMC), a smart media (SM) card, a memory stick (MS), a secure digital (SD) card, a compact flash (CF) card, and a micro drive (MD) card.

The interface 120 interfaces between the control part 160 and an information processor, such as a personal computer (PC), a universal serial bus (USB) high-capacity storage, or an external device 300 (which may be a digital camera), so as to receive data including various images applied from the information processor (such as the external device 300) and transmit various data including a photodrama from the photo printer 100 to the information processor (such as the external device 300).

The input part 130 may include a plurality of numeric keys and function keys and may apply a signal to the control part 160 corresponding to operating or requesting functions applied by the photo printer 100. Through the input part 130, a user is able to select functions to edit the photodrama.

In addition, the input part 130 may include a keyboard including a touch pad to provide a menu selection key to select assorted menus including a photodrama editing menu. Through the input part 130, the user can select images to compose the photodrama and menus to edit the photodrama, and the user can input various information including editing data. Moreover, the user can input various printing options to print the photodrama through the input part 130. For example, the printing options may include a duplex printing function, an N-up function to print multiple images on one page, a number of images per page when using the N-up function, printing resolution, and brightness.

The display part 140, which may be a liquid crystal display (LCD), displays an operation state of the photo printer 100. The user may select the images displayed on the display part 140 through the input part 130 and may input information required to edit a photodrama that includes the selected images.

The memory 150 may include a volatile memory to store various data generated during the operation of the photo printer 100, and a non-volatile memory to store various control programs to perform functions of the photo printer 100. In the present embodiment, the non-volatile memory of the memory 150 stores images to compose the photodrama. Also, when the photodrama is produced, the non-volatile memory may store the photodrama in a folder generated in advance in the memory 150, or may generate a new photodrama folder to store the photodrama and to store the images edited into the photodrama together with additional information thereof. The additional information may be stored as a separate file from the photodrama image file, or integrally with the photodrama image file. The photodrama folder will be described in greater detail hereinafter.

The control part 160 controls overall operations of the photo printer 100 according to the control programs stored in the non-volatile memory of the memory 150. The control part 160 performs digital signal processing, such as scaling, gamma conversion, and error diffusion, to convert the images stored in the mobile memory card 200 into printable image data.

Upon selection of a photodrama editing function through the input part 130, the control part 160 uses the photodrama folder generated and stored in advance or newly generates a photodrama folder in the non-volatile memory of the memory 150, in accordance with user's selection. When the images to compose the photodrama are selected and the required information including the editing data are input by the user, the control part 160 stores the required information including the editing data as the additional information of the corresponding images together with the images in the photodrama folder. The control part 160 may store the editing data integrally with the images in the photodrama folder, for example, in a header of image files of the images. Alternatively, the control part 160 may store the editing data as separate files separate from the image files of the images.

The printer engine 170 prints the image data generated by the control part 160. When using a dedicated photo paper, the user can obtain printout at least almost equivalent to real photo quality.

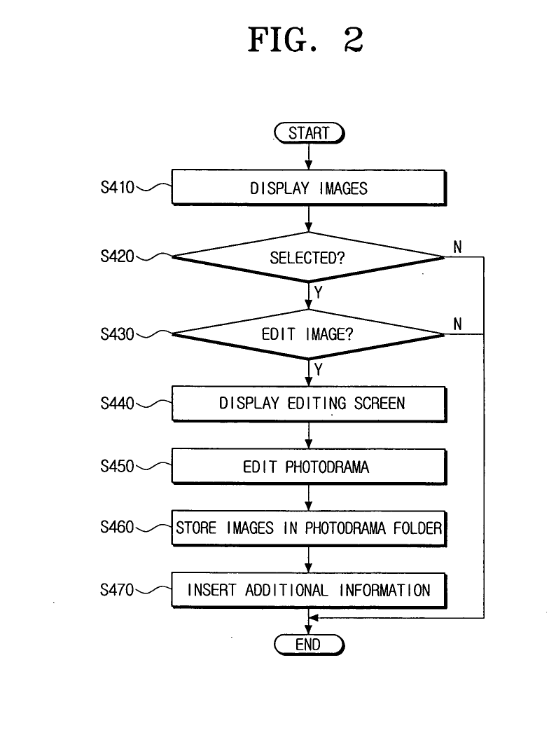

FIG. 2 is a flowchart illustrating operations of the photo printer 100 of FIG. 1 according to an embodiment of the present general inventive concept.

First, the control part 160 of the photo printer 100 receives photo images or animation images to compose a photodrama from an external and/or internal device (such as the memory 150, the mobile memory card 200, the external device 300, the information processor, the digital camera, and the USB high-capacity storage) through the card slot 110 or the interface 120, and displays the received images on the display part 140 (operation S410).

The control part 160 determines whether a predetermined image is selected by inputting a menu button with respect to the image displayed on the display part 140 or whether a still-cut image is selected by inputting a pause button or a stop button during reproduction of an animation image (operation S420).

Alternatively, where the menu button is input with respect to the displayed image, a file name of the image file may be selected or the predetermined image may be selected among a plurality of thumbnail images using direction keys, and then a specific key may be input.

In addition, although the stop button is input to select a predetermined still-cut image of the animation image in this embodiment, the present general inventive concept may adopt other methods. For example, a plurality of sequential images may be extracted from an animation image using a well-known animation image extraction method and sampled.

If the predetermined image is selected (operation S420:Y), the operation proceeds to operation S430. Alternatively, if a predetermined image is not selected (operation S420:N), the operation ends.

Upon selection of the predetermined image, the control part 160 determines whether a photodrama menu or function to edit the selected image into the photodrama is selected through the input part 130 (operation S430). When the photodrama menu or function is selected (operation S430:Y), the control part 160 displays an editing screen to edit the photodrama on the display part 140 (operation S440). Alternatively, when the photodrama menu or function is not selected (operation S430:N), the operation ends.

The user may then input various information, including the editing data, review the edition screen, and edit the photodrama (operation S450).

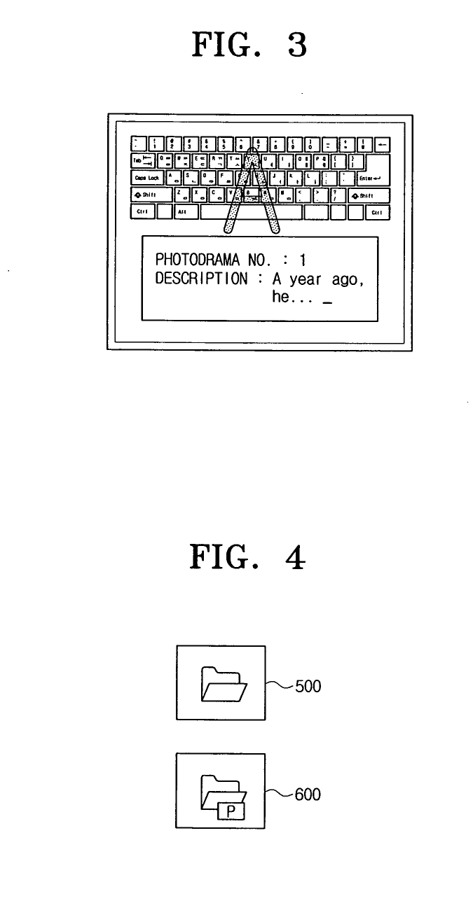

FIG. 3 is a view illustrating an exemplary editing screen of the photo printer 100 of FIG. 1 to edit a photodrama according to the method of FIG. 2.

Referring to FIGS. 1-3, a selected image is displayed on the editing screen of the display part 140 (operation S440 of FIG. 2). The input part 130 to input numbers and letters is displayed on the display part 140 as a keypad to overlap the selected image displayed on the display part 140. Editing data including texts, such as a photodrama number (e.g., an image sequence number) and an image description, can be input to the selected image (operation S450 of FIG. 2). Additionally, the input editing data, such as the photodrama number and the description, can be displayed on the editing screen of the display part 140 in the form of a pop-up window for the user's review.

On the editing screen illustrated in FIG. 3, “PHOTODRAMA NO.” refers to a position of the selected image in the photodrama relative to other images of the photodrama being edited. For example, the designation “PHOTODRAMA NO.: 1” illustrated in FIG. 3 indicates that the displayed image is first among a sequence of images of the photodrama. In addition, “DESCRIPTION” refers to words input to describe the corresponding images of the photodrama. However, other titles may be used and other data may be included. In addition, the editing data may include, for example, font type, text size, position of the description texts, and size of the selected image. The display part 140 may display a guide to input such editing data through the editing screen.

After selecting the predetermined image and editing the photodrama by inputting the editing data, the control part 160 generates a photodrama folder to store the edited images or stores the edited images in an existing photodrama folder (operation S460 of FIG. 2). The editing data may be stored as the additional information regarding the images, separately from the edited images, or may be stored by being inserted in the image file as an additional information file (operation S470 of FIG. 2). In a case where the editing data is stored separately from the edited images, the file including the editing data may be stored together with the file including the edited images so that the editing data can be processed together with the edited images when using the photodrama, for example, when storing, displaying, printing, and transmitting to the external device 300 or the memory card 200 the edited images.

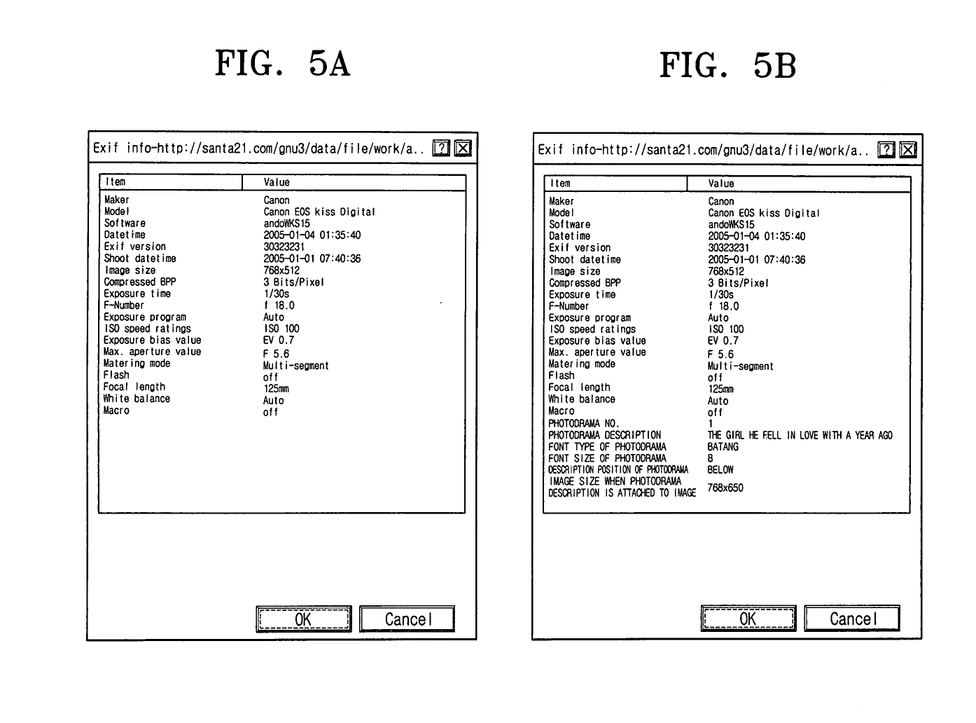

FIG. 4 is a view illustrating an exemplary icon denoting a photodrama folder 600 of the photo printer 100 of FIG. 1 according to an embodiment of the present general inventive concept.

Referring to FIG. 4, the photodrama folder 600 is displayed to be distinguishable from a general folder 500. In the general folder 500, files are arranged, managed, and displayed based on a date of a latest correction thereto or a file name thereof by applying a conventional file system. However, in the photodrama folder 600 according to the present embodiment, the image files are arranged, managed, and displayed based on an order determined by the user with respect to the image files composing the photodrama, for example, based on a photodrama image sequence number.

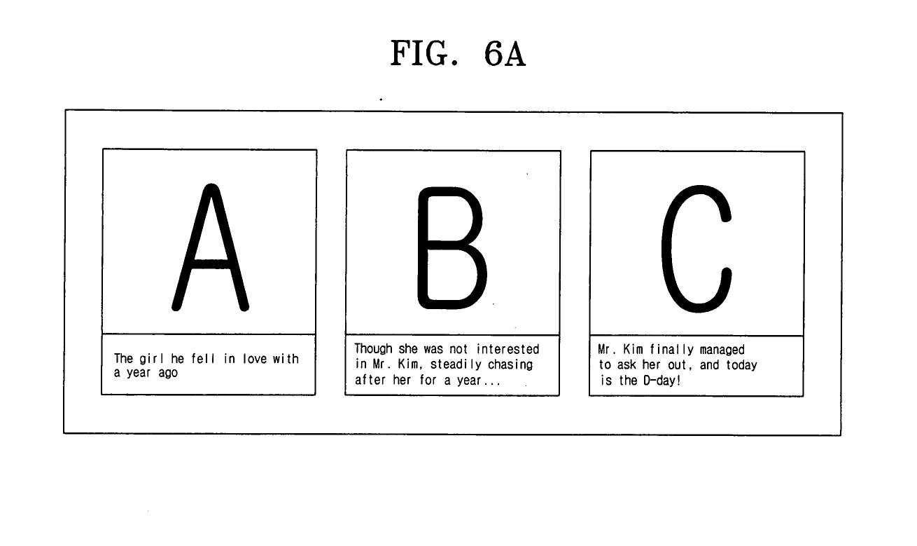

FIG. 5A is a view illustrating an exemplary Exif file stored as additional information of an image file being stored in the general folder 500 of FIG. 4. FIG. 5B is a view illustrating an exemplary Exif file stored as additional information of an image file being stored in the photodrama folder 600 of FIG. 4.

In addition to general information on the images, the additional information regarding the image file being stored in the photodrama folder 600 may include various information on the photodrama, which is necessary to edit, display, and print the photodrama. The additional information as the editing data of the photodrama may include a photodrama image number, a description of the photodrama, font type, text size, position of the description of the photodrama, and image size when attaching the photodrama description to the image file.

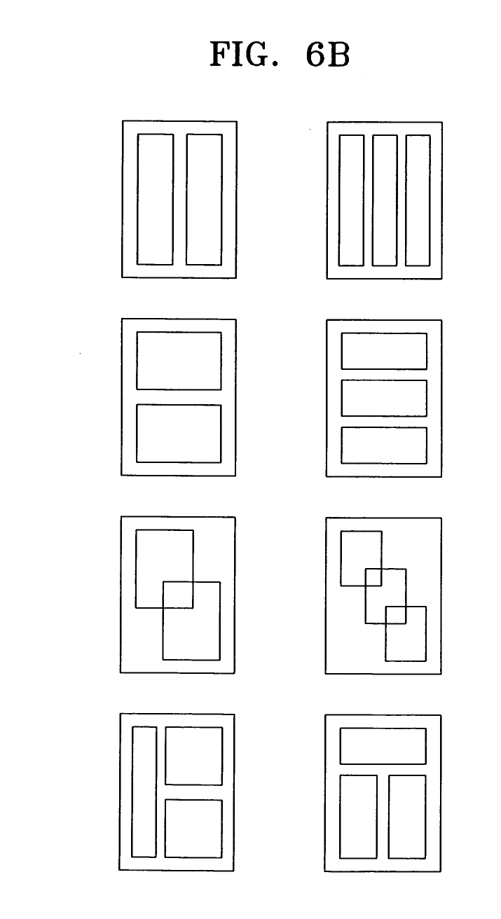

FIG. 6A is a view illustrating an example of a photodrama being displayed or printed through the display part 140 of the photo printer 100 of FIG. 1 according to an embodiment of the general inventive concept. The images are referenced by alphabet letters for a convenient explanation thereof.

When displaying or printing an edited photodrama, images stored in a corresponding photodrama folder are arranged according to an order determined by a user to be displayed or printed in the determined order. Here, contents of additional information stored with each image, such as Exif information on each image, is converted and the corresponding image is accordingly reconstructed. In addition, when printing the photodrama, printing data with respect to the reconstructed photodrama is generated and printed according to various printing options, such as duplex printing, printing resolution, and brightness.

In the present embodiment, as illustrated in FIG. 6A, three images “A,” “B,” and “C” are displayed in a predetermined order on the display part 140 if the photo printer of FIG. 1. In particular, photodrama image numbers “1,” “2,” and “3” of Exif information of images “A,” “B,” and “C,” respectively, are arranged in order of the photodrama image number when storing and displaying the photodrama images. A photodrama description is added thereto. A font type of the photodrama description illustrated in FIG. 6A is “batang,” a text size thereof is 8, an image size of each of “A,” “B,” and “C” is 768*650, and a position of the photodrama description is set to “below” each image. Such Exif information is converted, and the images are edited and displayed, thereby composing the photodrama, as illustrated in FIG. 6A.

FIG. 6B is a view illustrating exemplary layouts to display and print the photodrama of FIG. 6A according to an embodiment of the present general inventive concept. While the photodrama images being displayed or printed are arranged from the left to the right in FIG. 6A, the photodrama images of FIG. 6B are arranged in various ways according to layouts set by a user. Such layouts may be preset during editing of the photodrama or set as options to display or print the photodrama.

Various embodiments of the present general inventive concept can be embodied as computer readable codes on a computer readable recording medium. The computer readable recording medium may include any data storage device suitable to store data that can be thereafter read by a computer system. Examples of the computer readable recording medium include, but are not limited to, a read-only memory (ROM), a random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Various embodiments of the present general inventive concept may also be embodied in hardware or in a combination of hardware and software.

As described above, according to embodiments of the present general inventive concept, when images are selected according to a photodrama editing function of a photo printer, an editing screen is displayed. By inputting editing data through the editing screen, image files are arranged, stored, and displayed according to an order determined by a user using the editing data. Therefore, the user can edit the photodrama conveniently. In other words, a user's convenience is improved.

Furthermore, the editing data may be stored as an additional information file such as an Exif file, in a photodrama folder, together with corresponding image files. In this case, files in the photodrama folder are arranged according to an order set by the user, regardless of a general file arrangement basis, such as a file name or a file date. Also, the user can insert short texts as desired. As a result, demands of the user can be satisfied without causing additional costs.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of controlling an image forming apparatus to store a photodrama, the method comprising:
arranging and storing a plurality of image files in a photodrama folder based on corresponding input image information to display images of the image files; and
storing the input image information with the stored plurality of image files in the photodrama folder.

2. The method of claim 1, wherein the input image information comprises an arrangement order of the plurality of images.

3. The method of claim 1, wherein the storing of the input image information comprises:
storing the input image information as Exif files in the photodrama folder.

4. The method of claim 1, further comprising:
displaying the images; and
displaying an editing screen to input the input image information thereto.

5. The method of claim 4, wherein the editing screen comprises a keypad including numbers and letters to input the input image information.

6. The method of claim 5, wherein the displaying of the editing screen comprises:
displaying the input image information input through the keypad as a pop-up window.

7. The method of claim 1, wherein the photodrama folder is an existing photodrama folder or a new photodrama folder, and the storing of the input image information comprises:
storing the input image information in the existing photodrama folder with the plurality of image files, or creating the new photodrama folder and storing the input image information in the new photodrama folder with the plurality of image files as each of the plurality of image files is generated.

8. The method of claim 1, wherein the photodrama folder is represented by an icon distinguishable from other folders.

9. The method of claim 1, wherein the input image information comprises editing data to edit the images.

10. The method of claim 9, wherein the editing data comprises text to describe the images.

11. The method of claim 10, further comprising:
editing and displaying the text together with the images according to the input image information.

12. The method of claim 1, wherein, the storing of the input image information comprises:
storing the input image information as separate files separate from the plurality of image files in the photodrama folder.

13. The method of claim 1, wherein the storing of the input image information comprises:
storing the input image information integrally with the plurality of image files in the photodrama folder.

14. The method of claim 1, further comprising:
performing at least one of displaying and printing the images stored and arranged according to the input image information.

15. The method of claim 13, wherein, the performing of the at least one of displaying and printing comprises:
arranging the images based on a predetermined layout according to the input image information.

16. The method of claim 13, wherein, the performing of the at least one of displaying and printing comprises:
arranging the input image information together with the images.

17. The method of claim 13, further comprising:
inputting at least one of a display option and a print option; and
performing the at least one of displaying and printing according to the input at least one display option and print option, respectively.

18. An image forming apparatus, comprising:
a storage unit to store a photodrama folder containing a plurality of image files and corresponding input image information to display images of the image files; and
a control unit to arrange and store the plurality of image files in the photodrama folder based on the corresponding input image information, and to store the input image information with the stored plurality of image files in the photodrama folder.

19. An image forming apparatus to edit and store a photodrama, comprising:
a display unit to display an editing screen to edit one or more of a plurality of images;
a control unit to generate editing data corresponding to the one or more of the plurality of images to arrange, store, and display the plurality of images according to a predetermined order on the display unit; and
a storage unit to store the generated editing data in a photodrama folder together with image files corresponding to the plurality of images.

20. The image forming apparatus of claim 19, wherein the storage unit stores the generated editing data as separate files separate from the image files in the photodrama folder.

21. The image forming apparatus of claim 19, wherein the storage unit stores the generated editing data in a header of corresponding ones of the image files.

22. The image forming apparatus of claim 19, wherein the photodrama folder is a previously-created photodrama folder.

23. The image forming apparatus of claim 22, wherein the storage unit stores other folders, the other folders are represented by a first icon, and the photodrama folder is represented by a second icon that is visually distinguishable from the first icon.

24. The image forming apparatus of claim 19, wherein the photodrama folder is a newly-created photodrama folder.

25. The image forming apparatus of claim 24, wherein the control unit generates an icon representing the newly-created photodrama folder that is visually distinguishable from other folders stored in the storage unit.

26. The image forming apparatus of claim 19, wherein the control unit generates at least one of an image sequence number and an image description for the one or more of the plurality of images.

27. The image forming apparatus of claim 26, wherein the image description comprises a font type, a text size, and/or a position of the description.

28. The image forming apparatus of claim 19, wherein the display unit displays the editing screen as an options screen overlapping the one or more of the plurality of images to edit the one or more of the plurality of images.

29. A method of editing and storing a photodrama in an image forming apparatus, the method comprising:
displaying an editing screen to edit one or more of a plurality of images;
generating editing data corresponding to the one or more of the plurality of images to arrange, store, and display the plurality of images according to a predetermined order; and
storing the generated editing data in a photodrama folder together with image files corresponding to the plurality of images.

30. The method of claim 29, wherein the storing-comprises:
storing the generated editing data as separate files separate from the image files in the photodrama folder.

31. The method of claim 29, wherein the storing comprises:
storing the generated editing data in a header of corresponding ones of the image files.

32. The method of claim 29, wherein the photodrama folder comprises a previously-created photodrama folder.

33. The method of claim 32, wherein an icon representing the previously-created photodrama folder is visually distinguishable from other folders stored in the image forming apparatus.

34. The method of claim 29, wherein the storing comprises:
creating the photodrama folder; and
storing the generated editing data in the created photodrama folder together with the image files in the predetermined order.

35. The method of claim 34, wherein the storing further comprises:
creating an icon representing the created photodrama folder that is visually distinguishable from other folders stored in the image forming apparatus.

36. The method of claim 29, wherein the generating of the editing data comprises:
generating at least one of an image sequence number and an image description for the one or more of the plurality of images.

37. The method of claim 36, wherein the image description comprises a font type, a text size, and/or a position of the description.

38. The method of claim 29, wherein the displaying of the editing screen comprises:
displaying the editing screen as an options screen overlapping the one or more of the plurality of images to edit the one or more of the plurality of images.

39. A computer readable recording medium including a computer readable code to perform a method of editing and storing a photodrama in an image forming apparatus, the method comprising:
displaying an editing screen to edit one or more of a plurality of images;
generating editing data corresponding to the one or more of the plurality of images to arrange, store, and display the plurality of images according to a predetermined order; and
storing the generated editing data in a photodrama folder together with image files corresponding to the plurality of images.
